(19) United States
(12) Patent Application Publication
(10) Pub. No.: US 2008/0021747 A1
(43) Pub. Date: Jan. 24, 2008

(54) Method And Device For Dispatching A Plurality Of Physical Objects

(75) Inventors: Thomas Moeller, Guestrow (DE); Monika Strauss, Much (DE); Werner Pipenbacher, Weeze (DE); Olaf Schmitz, Willich (DE); Herbert Perschke, Neuss (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 11/578,652

(22) PCT Filed: Apr. 13, 2005
(86) PCT No.: PCT/EP05/03901

§ 371 Date: Aug. 3, 2007

(30) Foreign Application Priority Data
Apr. 16, 2004 (DE) 10 2004 019 232.4

(51) Int. Cl. G01C 21/34; G06Q 99/00

(52) U.S. Cl. 705/6

(57) ABSTRACT

A method of dispatching a plurality of physical objects is provided. The method includes associating a delivery address with physical objects; determining a sequence of delivery for the physical objects; and determining a transport area for the physical objects, the transport area includes at least one transport location. The physical objects are collected and jointly transported according to the determined transport area. Prior to delivery, the delivery addresses are entered into a data storage unit in a transportation vehicle in accordance with the delivery sequence. A navigation system aboard the transportation vehicle determines a route-optimized itinerary for delivering the physical objects.

### BACKGROUND

1. Field of the invention

The invention relates to a method as well as to a device for transporting a plurality of physical objects, whereby the objects are delivered and/or picked up.

2. Description of related art

German Preliminary Published Application DE 197 37 256 A1 describes a vehicle routing and guidance system with an in-vehicle navigation system and a superordinated stationary service system for providing navigation information. For this purpose, a driver in a vehicle enters a desired destination by means of an input device. The destination information as well as information about the current location of the vehicle are transmitted to the service system, whereby a self-locating system installed in the vehicle supplies the information about the current location. Taking traffic information into account, the service system calculates the optimal guidance, whereby a route between the location of the vehicle and the transportation destination is divided into sections. One segment of the route from the location of the vehicle to the end of a first section along the route to the transportation destination is transmitted to the navigation system of the vehicle and displayed there to the driver in the form of a graphic representation. If the vehicle is in the immediate vicinity of the end of the first section, then additional information about the current location of the vehicle is transmitted to the service system. If necessary, the service system carries out another calculation for the guidance and transmits another segment of the route leading from the current location of the vehicle to the end of a second section. This approach is repeated as a function of the number of sections until the vehicle has arrived at the transportation destination.

The above-mentioned system allows the calculation of the guidance, taking current traffic information into account that is output during the drive from the current location to the transportation destination. The calculation of the guidance takes place in the stationary service system, which has access to a geographic data record of the calculated route, whereby only segments of the route are transmitted to the navigation system.

A drawback of the above-mentioned system is that, during the drive, data has to be transmitted between the service system and the navigation system, at least at times. In this context, it cannot be ruled out that interference with the transmission will occur, giving rise to errors in the guidance. For example, the transmission by means of electromagnetic waves in built-up areas with a high density of construction is impaired by structure surfaces that exert an absorbing or scattering effect. Moreover, only one transportation destination per guidance event can be transmitted to the service system via the input device.

Japanese patent JP 2002 005673 relates to a navigation system that is used for delivering goods. In a server or in a mobile computer, a delivery sequence as well as a delivery route are drawn up on the basis of files containing street and house address cards and are transmitted, together with the files, to a terminal that is located in a delivery vehicle. During the delivery of the goods, the location as well as the route to the next delivery destination are displayed on the basis of the signals of a GPS navigation system utilizing the street and house address cards.

British patent application GB 2 364 800 A describes the planning of a delivery route as well as a GPS navigation. Here, it is provided that orders placed by customers through the Internet are stored in a database together with the delivery address. The delivery addresses are then used by a route planning program to determine a delivery route, whereby the program generates a route file as well as a route point file. The files are transmitted to a GPS receiver that is used to guide the driver of the delivery vehicle along the delivery route.

German Preliminary Published Application DE 100 31 834 A1 describes a route planning method in which a vehicle of a parcel delivery service is equipped with a route planning module that is connected to a GPS navigation device. The addresses of the parcels that are to be transported with the vehicle are read in by means of a barcode scanner, after which the route planning module determines an entire route optimized according to a specific criterion. The vehicle is then navigated along the determined route by means of the GPS navigation.

### SUMMARY

The invention is based on the objective of creating a method as well as a device for trouble-free and time-optimized transportation of any desired number of objects.

At least one delivery address is associated with the objects, in that a sequence for the transportation of the objects is determined, in that several objects are collected for joint transportation, in that the delivery addresses are entered into a data storage unit of a transportation means in accordance with the determined sequence,

in that the data is transmitted to a navigation system of the transportation means in such a way that it is determined to which transport location the objects are to be subsequently transported and in that the navigation system of the transportation means determines a route-optimized itinerary to the transport location for the next transportation event.

According to the invention, the determination of the sequence for the transportation of the objects is carried out for a large number of delivery addresses. The objective of the determination of the sequence is to obtain a route-optimized and/or time-optimized order for the delivery addresses that serves as the basis for the subsequent determination of the route-optimized itinerary from a current transport location to another transport location for the next transportation event as determined by the sequence. Here, in order to improve the capability of the time-optimized transportation, the method according to the invention functionally uncouples the determination of the transportation sequence from the determination of the route-optimized itinerary. Each of the two above-mentioned determinations is configured in such a way that the result is optimal in terms of the determination capability for each area of the transportation sequence determination and for the route-optimized itinerary determination.

The method according to the invention makes it possible to use almost any desired number of delivery addresses for the sequence determination. Due to the large number of delivery addresses taken into consideration for the determination, either a geographic area of a large size or else a large density of transport locations is taken into consideration for the determination and thus is optimized for the transportation.

The route between the location of the transportation means and the transport location of the next transportation event is viewed according to the invention as a continuum of the locations and is not divided into sections. Hence, the method according to the invention makes it possible to determine the sequence taking into consideration additional delivery addresses which lie outside of a section that is to be optimized.

The method according to the invention makes it possible to deliver objects from a logistics center to the transport locations and/or to pick up objects from transport locations for purposes of subsequent transportation to the logistics center and/or to other transport locations. Hence, the sequence determination also takes into consideration delivery addresses of objects that are situated at transport locations and not in the logistics center for purposes of being loaded onto the transport vehicle. Thus, for example, the sequence determination takes into consideration those objects that are transported from transport locations to the logistics center, whereby it is an also option to deliver objects to the transport locations where objects are picked up.

The sequence determination and/or alternatively the determination of the route-optimized itinerary is usually carried out taking into consideration geographic data that is continuously updated, said geographic data being provided via defined and adaptable interfaces. The determination is also supported through external digital road networks. The basis for the management of the geographic data is a system for road digitization, house number acquisition, traffic guidance acquisition, geo-encoding of delivery addresses and for digital imaging of route-optimized transportation itineraries.

The geographic data is preferably based on a reference system for measuring individual geographic points within a geographic area determined by the geographic data. An example of a reference system of the geographic data is a worldwide geodetic system (World Geodetic System 1984-WGS 84), whose model description is based on an earth ellipsoid—also referred to as a global rotation ellipsoid—whereby the earth ellipsoid approximates the earth surface at sea level. Geographic data that images, for example, geographic areas in Europe, is preferably based on a Bessel ellipsoid.

Preferably, the sequence determination is carried out taking a Gauss-Krüger coordinate system into consideration, which makes it possible to assign a Gauss-Krüger coordinate to any desired point on earth, whereby the Bessel ellipsoid is used as the reference ellipsoid for the assignment. Subsequent to the sequence determination on the basis of the Gauss-Krüger coordinate system, the ascertained data from the Gauss-Krüger coordinate system is transformed into the WGS 84. The sequence determined on the basis of the WGS 84 is used for input into the data storage unit of the transportation means. Moreover, other reference systems for measuring the geographic points can be integrated without having to additionally modify the method according to the invention.

The geographic data is imported and processed by external data management systems. An example of an external data management system is a Storage Area Network (SAN). Storage Area Networks compile all data storage units into a dedicated network designed exclusively for this purpose. Access from a computer to the memory of the SAN—wherein the storage units can be physically separated from the computer—is technically comparable to access of the computer to a local hard drive.

The term “computer” is by no means to be construed in a limiting manner. It can be any unit that is suitable for performing calculations, for example, a work station, a personal computer, a microcomputer or a circuit that is suitable for performing calculations and/or comparisons.

In order to access the SAN, host bus adapters (HBAs) are used that allow data transmission via fiber-optic cables. For purposes of data transmission, the HBAs have technical properties that are similar to those of control chips of small computer system interfaces (SCSI controllers). The SAN inexpensively offers highly available storage space, whereby individual data storage units of the SANs are combined and configured as a RAID 5 system and are redundantly available on a client.

Moreover, regular automated merging procedures are used to integrate geographic data whose information content goes beyond the geographic data of the data management system. A data storage system, consisting of several servers, for example, up to 100, servers, preferably 5 to 30 servers, is available for the data integration. A data storage system consisting of 14 servers, for instance, has a data storage capacity totaling 9 terabytes. Among other things, the currently stored digitized geographic data serves to depict the road layout in Germany with all of the streets and house numbers, with a coverage of 100 percent.

If necessary, the available storage capacity of each server can be divided into individual storage systems, each having a storage capacity of 250 gigabytes.

The sequence determination is carried out by a modularly structured interface-capable data processing unit, whereby a processing syntax specially developed for processing large volumes of data is used for the process control. The mathematical models upon which the sequence determination is built are based, for example, on traverse surveying or triangulation processes. A typical example of a triangulation process is a Delaunay triangulation that creates a triangular network from a set of points. The basis of the Delaunay triangulation is a circumcircle condition according to which the circumcircle of a triangle may not contain any other points of the prescribed set of points. Due to the circumcircle condition, Delaunay triangulations maximize the smallest interior angles of all of the triangles.

Preferably, in order to determine the sequence, a server/client concept having a modern network architecture is employed. Here, the data processing unit consists, for example, of several servers. The servers are connected to each other and to at least one client by means of a network that can be the Internet or a Local Area Network (LAN) or any other network. The connection of several servers achieves an optimized determination capability, whereby interactive and/or long-running processes are involved in the determination of the sequence. Moreover, the determination capability of the server is improved by means of load balancing between the individual servers, which leads to a better capacity usage of the group of servers. Within the scope of load balancing, all of the available system resources are utilized in order to increase the process-based computing power of the server and these resources are activated as a function of the underlying complexity of the determination.

In order to collect the objects for joint transportation, for example, a suitable encoding in the form of a destination code (conventional barcode or, for instance, 4-state code) and/or in the form of a mechanically printed postal code in plain text or in the form of an appropriate manually or mechanically applied label with the address in plain text or in encrypted form ensures that the objects can be mechanically sorted and subsequently transported to the transport locations especially efficiently.

The inventive data storage unit of the transportation means can be either an autonomous storage unit or a storage unit that belongs to the navigation system. Examples of data storage units are diskettes, CD-ROMs, read-only memory (RAM), hard drives, digital audio tape (DAT) or memory sticks.

The transportation means can be, for example, a passenger car, a truck or a bicycle.

According to the invention, satellite-aided navigation systems have proven to be especially advantageous. A typical satellite-aided navigation system is based on the so-called “Global Positioning System (GPS)”. The objective of GPS-aided navigation is the immediate determination of the position and momentary speed of the transportation means that is located anywhere on the earth and that is equipped with a suitable receiver. In order to always ensure the integrity of this process, at least four satellites are electronically visible simultaneously and from any point on earth.

The objective of determining the position of the transportation means, for example, according to its latitude, longitude and altitude, is achieved by means of a resection process (satellite triangulation) employing the measured distances to the satellites. In this process, the satellites are considered to be stationary for a brief moment so that propagation times of signals between the satellites and the receiver are measured. A prerequisite for the determination of the propagation times is a precise time setting of the clock of the receiver to correspond to the GPS time. In this case, only three satellites are needed in order to determine the unknowns in question, namely, latitude, longitude and altitude. However, since the GPS receivers are normally equipped with a simple crystal oscillator-based clock and since this is only set to correspond approximately to the GPS system time, slight offsets result and the actual distance from the satellite can be longer or shorter than measured. This is compensated for through the simultaneous use of four satellites. The “clock error” is ascertained by the additional satellite.

The GPS receiver according to the invention offers a precision of up to a few meters. The crucial aspect for the precision is the number of receiving satellites and the geometry relative to the GPS receiver, so that in actual practice, precision of 10 meters are attained.

The determined current position of the transportation means is related to the geographic data. The route-optimized itinerary between the determined position and the next transport location, which was specified by the previously determined sequence, is subsequently ascertained. In order to determine the route-optimized itinerary, commercially available optimization methods for calculating the itinerary, for example, are a possibility and the person skilled in the art can glean these methods from the generally available technical literature.

Moreover, the navigation system according to the invention has a modular structure thanks to which system components can be retrofitted in order to improve the determination time of the route-optimized itinerary.

The overall costs for implementing the method according to the invention are extremely low in the case of the satellite-aided navigation system. This financial aspect reveals another advantage of the invention since the method according to the invention can be retrofitted in already existing and fully functional vehicles without additional technical work and thus with low financial expenditures.

In one embodiment of the invention, the route-optimized itinerary to the transport location for the next transportation event is determined by means of additional route points.

The use of additional route points functions as a route guidance, at least in sections in the area of the additional route points, while the route points—in terms of the route determination—function as additional transport locations. The route determination without additional route points could, for example, cause the route-optimized itinerary to run through a zone with a speed limit which, from the standpoint of a time-efficient transportation of the objects, would unnecessarily prolong the time needed. Consequently, additional route points are preferably used in cases in which the transportation would require more time due to evaluations of geographic data without additional route points.

The additional transport locations for determining the route-optimized itinerary are not displayed in or on the transportation means during the guidance to the next transport location. As an alternative, the additional transport locations can be displayed in or on the transportation means as route points situated along the itinerary.

In another embodiment, the sequence determination for the transportation of the objects leads to the determination of at least one transport area, whereby the determined transport area comprises at least one transport location.

This embodiment allows the determination of transport areas, taking into account the delivery addresses for each further sequence determination. Accordingly, transport areas of a transportation event are preferably determined on the basis of the delivery addresses at hand, thus avoiding a one-time definition of transport areas. The transport areas are unspecified before the determination and are only specified as a result of the sequence determination, which is equivalent to a dynamic determination of the transport areas for each of the delivery addresses at hand. For each determination of the transportation sequences, delivery addresses with any location patterns in the geographic area can be used, which leads to the determination of transport areas of any configuration in terms of their geography. The dynamic determination of the transport areas for each of the delivery addresses that form the basis of the determination is oriented according to the actually existing current transportation volume and leads to a uniform capacity utilization of all of the deliverers of the logistics center with concurrent time-optimized and route-optimized itinerary determination, which ultimately also leads to the avoidance of unnecessarily long transportation times.

In another embodiment of the invention, transport results of completed transportation events are incorporated into the determination of the transport area.

This embodiment of the invention makes it possible in a beneficial manner to adaptively utilize the transport results of previous transportation events for further determinations of transport areas. Examples of transport results that are incorporated into the determination of the transport area include a prolonged transportation time due to adverse geographic conditions in the transport areas or due to changed physical access to individual transport locations, insofar as these transport results are not automatically taken into consideration through the updating of the geographic data. Especially in cases in which so-called bicycle couriers are used for the transportation and in which the transportation means is a bicycle, it has proven to be advantageous to incorporate into the determination the transport results in the form of information about the geographic layout of the transport area and about the number of inclines and slopes within the transport area.

In another embodiment, objects for joint transportation are collected according to the determined transport area.

This approach makes it possible to meet the demands of logistic sequences—for example, efficient warehouse organization and time management. Advantageously, more efficient warehouse organization ensues from collecting the objects for joint transportation since, at any point in time, precise information is available about the quantity and size of the objects to be delivered. Hence, the collection allows a faster loading of the transportation means subsequent to the collection since, for example, suitable loading boxes can be provided on the basis of the information about the quantity and size. The provision of loading boxes prior to the loading makes it possible to deliver the objects more time-efficiently or to achieve an improved loading quality since the time gain thus attained can, if desired, be used for more efficient loading. Examples of efficient loading are the use of special loading boxes for loading objects that are sensitive to motion, temperature or pressure.

In another embodiment of the invention, the transportation means are assigned to the collected objects.

Consequently, if geographic parameters of the determined transport areas as well as the quantity and size information about the objects to be delivered are taken into consideration, suitable transportation means can be selected. Suitable transportation means are those whose cargo space is adapted to the quantity and size of the objects to be delivered or whose vehicle dimensions allow problem-free transportation in highly built-up areas. For example, it is advantageous to select transportation means as a function of the street dimensions in highly built-up areas so that said transport vehicles can drive through streets without having to maneuver repeatedly. Moreover, allocation charts can be generated for an entire fleet of transportation means, said charts being designed flexibly for the determined transport areas.

In another embodiment, when the objects are delivered to the transport locations, the delivery addresses are assigned on the basis of destination codes located on the objects, whereby the destination codes are read in and decoded in a logistics center.

Preferably, the destination codes located on the objects, whereby these are advantageously 2D barcodes, are read in by means of an address reading machine in the logistics center. When 2D barcodes are used for encoding the destination codes, the address reading machines is advantageously a barcode reader.

Destination codes can also be any encoding measures for encrypting information. The destination codes contain at least information about the delivery address of the appertaining object. During the processing of the objects within the logistics center, a validity test is carried out to check the decoded content of the read-in destination code for logical plausibility. The validity test especially comprises methods for processing mailpieces with address flaws for domestic delivery that until now were not machine-readable or else that could not be sorted by means of video encoding or manually. Examples of address flaws are a missing, old or wrong postal code, a misspelled city or street designation, an old city or street designation, a missing or wrong post office box number as well as a missing street designation and/or a missing house number.

The read-in delivery addresses are associated with the objects subsequent to the validity test, whereby, in a data storage unit, a consecutive number is linked to the checked delivery address in order to identify the object. The linking of the delivery address is preferably carried out with additional contents of the decoded, read-in destination code, whereby each destination code is unique and can thus be unambiguously associated with an object.

In another embodiment, the delivery addresses are entered into the data storage units of the transportation means by means of a chip card. The chip cards employed are designed to be sturdy and to have a long service life, as a result of which they allow a practical and reliable input of the delivery addresses. The determination of the delivery addresses can also take place at a site that is far from the loading site of the transportation means, so that carrying the lightweight chip card and subsequently entering the delivery addresses are especially easy to perform.

Synchronous as well as asynchronous chip cards are used. Synchronous chip cards preferably consist of a non-encryptable read/write memory that allows rapid data access for reading in as well as reading out the delivery addresses for purposes of entering of the delivery addresses into the data storage unit. Individual memory cells of the chip card can be accessed sequentially via an interface.

Asynchronous chip cards have a microprocessor that controls the access to the stored delivery addresses, whereby the access is protected against outside influence by means of cryptographic methods.

An example of a chip card is a SIM card (Subscriber Identification Module card).

In another embodiment, the delivery addresses are entered into the data storage unit of the transportation means by means of a Bluetooth interface.

Advantageously, the Bluetooth interface allows wireless data transmission between a transmitter and a receiver. Technical specifications of Bluetooth technology are familiar to the person skilled in the art and can be found in the general technical literature. The transmitter and the receiver are equipped with a Bluetooth chip for controlling the transmission and reception. The data is transmitted in the shortwave radio range at,a frequency of approximately 2.45 Gigahertz in the Industrial Scientific Medical (ISM) network, which can be utilized worldwide license-free, whereby multiple data transmission channels are available. A typical range for the data transmission is about 10 meters, but if so desired, can be increased to about 100 meters through the use of suitable amplification means. The maximum transmission speed is about 1 megabit/second.

In another embodiment, the delivery addresses are entered into the data storage unit of the transportation means by means of a microdrive card.

The microdrive card is a hard drive for magnetic storage of the delivery addresses with a storage capacity of either 340 megabytes, 412 megabytes or 1024 megabytes, whereby storage media rotate at about 3600 rpm in a card housing of the microdrive card. The data from the microdrive card is transmitted to the data storage unit of the transportation means at about 4.2 megabytes/second.

In another embodiment, the delivery addresses are entered into the data storage unit of the transportation means by means of a mobile computer.

The use of a mobile computer is made possible through a suitable interface to the data processing unit. The mobile computer is preferably a commercially available device for receiving, storing and transmitting electronic data of the type known in the realm of general communication electronics. The mobile computer can be a laptop, a notebook, a so-called “personal assistant” or else part of a cell phone. Connections to the data storage unit of the transportation means are established by commercially available means, whereby a universal serial data bus (USB) has proven to be especially advantageous. In this context, a USB stick, an electronic memory chip (static RAM, EEPROM) that is inserted as a plug into a USB connection, all constitute a mobile computer as set forth in the embodiment.

Due to the widespread distribution of the above-mentioned commercially available devices, their use considerably reduces the costs for entering the delivery addresses since no additional new equipment has to be developed for entry purposes.

In another embodiment, the delivery addresses are entered into the data storage unit of the transportation means by means of an INCA terminal.

The INCA terminal is a highly advanced handheld device with an optical user interface. It is dust-tight, protected against water and being dropped and consequently it is suitable for entering delivery addresses into the data storage unit of the transportation means. The INCA terminal can be connected to the data processing unit so as to temporarily store the determined transportation sequence of the delivery addresses in the memory of the INCA terminal. The INCA terminal is subsequently connected to the data storage unit of the transportation means, whereby the delivery addresses are read into the data storage unit in an automated process.

Moreover, during the transport of the objects, the INCA terminal can be used by the deliverer to transmit queries to the data processing unit via radio using a server of a global telecommunication system (GSM), said queries relating to a renewed determination of the transportation sequence. The newly determined transportation sequence can be transmitted from the data processing unit to the INCA terminal, whereby subsequent to the transmission, the delivery addresses are entered into the data storage unit of the transportation means. If necessary, the transportation sequence can be determined anew during the transportation procedure so as to adapt the transportation sequence to new circumstances, a situation that could arise, for example, if a delivery address is eliminated.

Moreover, the INCA terminal makes it possible to enter order data at the transport location so that this data can be automatically incorporated into a central order database. This order database is located, for example, in the logistics center.

The device according to the invention has a means for reading in and associating delivery addresses as well as a data processing unit for determining a transportation sequence for the objects, whereby the data processing unit is connected to at least one external data management system and to at least one data storage system for managing and storing geographic data, wherein it has a sorting means for sorting the objects and wherein it also has a loading device for loading a transportation means with the sorted objects, whereby it also has a means for entering the determined transportation sequence into a data storage unit of the transportation means.

The above-mentioned advantages are achieved in that, after the objects are received at a warehouse—whereby the warehouse can be, for example, the logistics center—the compact and also extremely functional structure of the device in terms of transportation of the objects makes it possible to carry out the processing, the sorting in preparation for the transportation as well as the loading of the objects into the transportation means. The device also allows the sorting of objects taking into consideration the determined transportation sequence, whereby the transportation sequence translates into the route-optimized and/or time-optimized order of the delivery addresses. Due to the managed and stored geographic data, the route-optimized and/or time-optimized order is kept highly up-to-date in terms of street layouts, traffic pattern detection, geo-encoding of delivery addresses, changes in delivery addresses and it also serves to provide for digital imaging of route-optimized transportation itineraries. The provision of this updated geographic data, as the basis for determining the transportation sequence, is made possible by the inventive connection of the data processing unit to at least one external data management system and to at least one data storage system.

In another embodiment, the means for entering the determined transportation sequence into the data storage unit of the transportation means is a chip card, a Bluetooth interface, a microdrive card, a mobile computer or an INCA terminal.

This flexibility in the selection of the means for entering the determined transportation sequence adapts the device to various embodiments of the navigation system installed in the transportation means or to the data storage unit of the transportation means. This highly adaptive flexibility is made possible by a modular structure of the device so that, within a very short period of time, the entry means is adapted to the entry requirements of the data storage unit. Furthermore, the output of data about the determined transportation sequence may be configured in such a way that a subsequent adaptation of the output to new input means is considerably simplified.

In another embodiment of the device according to the invention, the external data management system is a Storage Area Network (SAN), whereby host bus adapters (HBAs) are used to access the SAN.

The SAN is free of the administration problems encountered with hard drives and thus allows an almost unlimited, efficient and flexible utilization of the available storage capacity.

Moreover, already existing networks are not burdened with access operations to the hard drive. It has proven to be advantageous to configure the SAN using fiber-optic cables. In its simplest embodiment, the SAN consists of a “fiber channel switch”, one or more hard drive subsystems and several servers, whereby the servers are connected to the fiber channel switch by means of the host bus adapter.

Typical bandwidths of the SAN lie in the range of 1 gigabit/second to 4 gigabits/second, whereby a protocol adapted to the requirements of mass memory utilization is used. Moreover, in case of access of a server to several hard drive subsystems via several host bus adapters, a data transfer between the systems may be performed via several data paths, which further increases the transfer rate.

In another embodiment, the data processing unit consists of several servers in order to achieve an optimized determination capability, whereby long-running processes are involved in the determination of the transportation sequence.

An upper limit of the number of servers that constitute the data processing unit basically depends on the number of servers that are available. For example, the data processing unit can consist, among other things, of web servers of the Internet as well as LAN servers of the Local Area Network, whereby several hundred servers are simultaneously connected.

Consequently, the long-running processes can be distributed over several servers for purposes of processing and thus determining the transportation sequence.

Further advantages, special features and advantageous embodiments of the invention can be gleaned from the presentation below of preferred embodiments making reference to the figure.

### BRIEF DESCRIPTION OF THE DRAWING

FIG. 1 shows a schematic diagram of a system for dispatching a plurality of physical objects constructed in accordance with the teachings of the disclosure.

### DETAILED DESCRIPTION

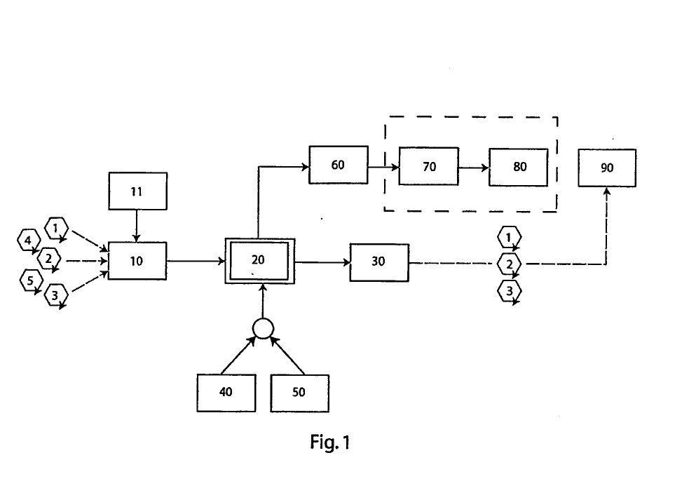

Referring now to FIG. 1, after physical objects 1-5 are received in the logistics center, the physical objects 1-5 are associated with delivery addresses by a reading-in and association means 10. The physical objects 1-5 are oriented along a conveying line or, as an alternative, in a conveyor in such a way that 2D barcodes located on the physical objects 1-5 can be read directly by a barcode reader and subsequently decoded.

Moreover, a validity test of the decoded contents of the read-in 2D barcodes is based on logical plausibility. Among other things, the validity test makes it possible to detect forged 2D barcodes as such and to initiate suitable measures for the further handling of the physical objects 1-5 with forged barcodes. The validity test also comprises methods for the processing of the physical objects 1-5 with address flaws. For this purpose, at least the delivery addresses ascertained on the basis of the 2D barcodes as well as determined mailpiece data are compared to already stored addresses and shipment data, which offers enhanced security in determining the contents of the 2D barcodes. If the contents of a 2D barcode cannot be detected by the barcode reader, as an alternative, a graphic image of a surface of the object is generated, whereby the surface comprises at least one address field. Subsequent to the generation, an automated check is performed of the information in the graphic image on the basis of which the delivery address can be determined. This redundancy is introduced in the determination of delivery addresses by optionally checking the graphic information since the determination of the delivery addresses in case of the delivery of the physical objects 1-5 is a prerequisite for the association of the read-in delivery addresses with the physical objects 1-5. The association is carried out after the validity test, whereby for each physical object 1-5, the delivery address is linked with the contents of the decoded read-in destination code each physical object 1-5.

The delivery addresses of the physical objects 1-5 that are picked up at transport locations are also incorporated into the determination of the sequence and are supplied to the reading-in and association means 10 by another data storage unit 11.

On the basis of the delivery addresses and the geographic data of a data management system 40 as well as of a data storage system 50, the transportation sequence of the delivery addresses is determined by the data processing unit 20. The data management system 40 transmits the geographic data to the data processing unit 20, whereby the geographic data is subject to updating at predefinable cycles in the data management system 40. In order to improve this updating cycle of the data management system 40, if applicable, geographic data of the data storage system 50 is transmitted to the data processing unit 20, insofar as the data of the data storage system 50 is more up-to-date than that of the data management system 40, so as to ensure the provision of geographic data that is kept highly up-to-date at all times.

The determined transportation sequence is transmitted to a sorting means 30 so that, from the plurality of physical objects 1-5, those physical objects 1-5 whose delivery addresses are part of the determined transportation sequence are collected for joint transportation. FIG. 1 illustrates this process of collection purely by way of an example on the basis of the depiction of three selected objects 1-3 from the set of objects 1-5 arriving in the logistics center. Fundamentally, the number of collected objects can be smaller than or equal to the number of arriving objects.

Subsequent to the collection, a loading device 90 loads a transportation vehicle with the collected objects 1-3. In this process, as set forth in the embodiment, the design structure of the transportation vehicle is totally immaterial for the successful loading since the loading device 90 can be adapted to the structure.

Moreover, the determined transportation sequence is transmitted from the data processing unit 20 to an input means 60 and, through the input means 60, the determined transportation sequence is entered into the data storage unit 70 of the transportation vehicle. In the present case, transmission from the data processing unit 20 to the input means 60 may take place by means of a USB connection. Since the input means 60 of the preferred embodiment is a Bluetooth interface, a wireless data transfer takes place between the interface and a receiver of the data storage unit.

According to the entered transportation sequence, the delivery addresses are transmitted consecutively to a navigation system 80 making use of a hard-wired or wireless connection, so that no matter where the transportation vehicle is located, which in the ideal case is a previous transport location, a route-optimized itinerary to the transport location for the next transportation event can be determined.

If objects 1-5 are picked up from transport locations, then, at the transport location, data about the object 1-5 to be picked up is read in from an order sheet by means of the barcode reader so that the pick-up can be registered. Order sheets are generated in the mail center before the start of the transportation procedure and they are located in the transportation means.

Subsequent to receipt of the object, receipt is confirmed directly at the transportation location by reading in data from a barcode located on the object 1-5. For confirmation purposes, the data read in from the order sheet is related to the data read in from the barcode located on the object 1-5.

### LIST OF REFERENCE NUMERALS

1-5 objects
10 reading-in and association means
11 data storage unit
20 data processing unit
30 sorting means
40 data management system
50 data storage system
60 input means
70 data storage unit
80 navigation system
90 loading device

1. A method for transporting a plurality of physical objects, whereby the objects are delivered and/or picked up, the method comprising the steps of:
associating at least one delivery address is with each object in the plurality of physical objects,
determining a sequence for the transportation of the plurality of physical objects,
determining of at least one transport area for the sequence of transportation of the plurality of physical objects, whereby the determined transport area comprises at least one transport location,
collecting the plurality of physical objects for joint transportation according to the determined transport area,
entering the delivery addresses are entered into a data storage unit of a transportation vehicle in accordance with the determined sequence,
transmitting the delivery addresses to a navigation system of the transportation vehicle,
determining to which transport location the plurality of physical objects are to be subsequently transported, and
determining route-optimized itinerary to the transport location for a subsequent transportation event.

2. The method according to claim 1,
wherein additional route points are used to determine the route-optimized itinerary to the transport location for the subsequent transportation event.

3. The method according to claim 1,
further comprising incorporating transport results of completed transportation events into the determination of the transport area.

4. The method according to claim 1,
wherein one or more transportation vehicle are assigned to the collected plurality of physical objects.

5. The method according to claim 1,
further comprising assigning the delivery addresses on the basis of destination codes located on the plurality of physical objects, whereby the destination codes are read in and decoded in a logistics center.

6. The method according to claim 1,
wherein the delivery addresses are entered into the data storage unit of the transportation vehicle with a chip card.

7. The method according to claim 1,
wherein the delivery addresses are entered into the data storage unit of the transportation by vehicle with a Bluetooth interface.

8. The method according to claim 1,
wherein the delivery addresses are entered into the data storage unit of the transportation vehicle with a microdrive card.

9. The method according to claim 1,
wherein the delivery addresses are entered into the data storage unit of the transportation vehicle with a mobile computer.

10. The method according to claim 1,
wherein the delivery addresses are entered into the data storage unit of the transportation vehicle with an INCA terminal.
